(19) United States
(12) Patent Application Publication
(10) Pub. No.: US 2017/0075883 A1
(43) Pub. Date: Mar. 16, 2017

(54) MACHINE TRANSLATION APPARATUS AND MACHINE TRANSLATION METHOD

(71) Applicant: Kabushiki Kaisha Toshiba, Tokyo (JP)

(72) Inventor: Satoshi KAMATANI, Kawasaki Kanagawa (JP)

(21) Appl. No.: 15/260,770

(22) Filed: Sep. 9, 2016

(30) Foreign Application Priority Data
Sep. 15, 2015 (JP) 2015-182100

(51) Int. Cl. G06F 17/28; G06F 17/27

(52) U.S. Cl. CPC G06F 17/2836; G06F 17/2854; G06F 17/2735

(57) ABSTRACT

According to an embodiment, a machine translation apparatus includes a translator, a determiner, a requester, a receiver and a learner. The translator performs machine translation of an original language text based on a dictionary. The determiner calculates an evaluation value indicating validity of the machine translation text. The requester requests a human translator to perform a manual translation-related work relative to the original language text corresponding to the machine translation text that has been determined to be insufficient in translation quality. The receiver receives a result that the human translator has created in response to a request of the manual translation-related work. The learner updates the dictionary based on the result.

### CROSS-REFERENCE TO RELATED APPLICATIONS

This application is based upon and claims the benefit of priority from Japanese Patent Application No. 2015-182100, filed Sep. 15, 2015, the entire contents of which are incorporated herein by reference.

### FIELD

Embodiments described herein relate generally to machine translation.

### BACKGROUND

Machine translation is a technique for mechanically converting an input original language text into a target language text. For example, statistical machine translation (hereinafter, referred to as “statistical translation”), which is one of the techniques of machine translation, is a technique of learning a statistical model based on bilingual data in which an original language text and a target language text which is a correct translation text are associated with each other, and generating the most probable translation results by using the learned statistical model. The statistical translation has advantages in that translation results can be obtained in a short time if a sufficient amount of bilingual data is prepared. For example, an effective learning method is known for a type of statistical model, a translation model, which defines the validity of the translation (for example, likelihood of translation words or phrases).

In order to improve the accuracy of machine translation which includes the statistical translation, it is necessary to translate various input texts, to evaluate the quality of translated texts, to recreate correct translation texts if the quality is insufficient, and to learn the statistical model or update a dictionary based on bilingual data including the correct translation texts. However, manually creating a large number of correct translation texts with high quality incurs enormous costs and time. Accordingly, it is required to effectively collect a sufficient amount of bilingual data with high quality to construct a highly-accurate machine translation system with low costs. A technique of acquiring manually created translation results through a network is also known. However, significant cost reductions may not be expected by merely collecting bilingual data through a network.

### BRIEF DESCRIPTION OF THE DRAWINGS

FIG. 1 is a block diagram showing a machine translation apparatus according to the first embodiment.

FIG. 2 illustrates a translation-related work generated by a work generator shown in FIG. 1.

FIG. 3 illustrates a translation-related work generated by the work generator shown in FIG. 1.

FIG. 4 illustrates a translation-related work generated by the work generator shown in FIG. 1.

FIG. 5 illustrates a translation-related work generated by the work generator shown in FIG. 1.

FIG. 6 illustrates an evaluation work generated by the work generator shown in FIG. 1.

FIG. 7 illustrates a translation-related work result received at a translation-related work receiver shown in FIG. 1.

FIG. 8 illustrates an evaluation work result received at an evaluation work receiver shown in FIG. 1.

FIG. 9 illustrates a maximum likelihood text and additional information output by an output shown in FIG. 1.

FIG. 10 illustrates a user evaluation result received at a user evaluation receiver shown in FIG. 1.

FIG. 11 is a block diagram showing a variation example of FIG. 1.

FIG. 12 is a block diagram showing a variation example of FIG. 1.

### DETAILED DESCRIPTION

A description will now be given of the embodiment with reference to the accompanying drawings.

According to an embodiment, a machine translation apparatus includes a translator, a determiner, a requester, a translation result receiver and a translation learner. The translator performs machine translation of an original language text based on a dictionary to generate at least one machine translation text. The determiner calculates an evaluation value indicating validity of the machine translation text using an evaluation model, and determines that a translation quality of the machine translation text is insufficient when the evaluation value is less than a first threshold value. The requester requests a human translator to perform a manual translation-related work relative to the original language text corresponding to the machine translation text that has been determined to be insufficient in translation quality. The translation result receiver receives a translation-related work result that the human translator has created in response to a request of the manual translation-related work. The translation learner updates the dictionary based on the translation-related work result.

In the descriptions below, the same reference numerals or symbols will be used to refer to explained elements or similar elements, and redundant descriptions will be omitted.

In the following description, it is assumed that an original language is Japanese, and a target language is English in a machine translation explained in the embodiment. However, the original language and the target language are not limited thereto. One of or both of the original language and the target language may be multiple languages. In the embodiment, the machine translation is accomplished by suitably modifying processing in accordance with a combination of an original language and a target language.

### First Embodiment

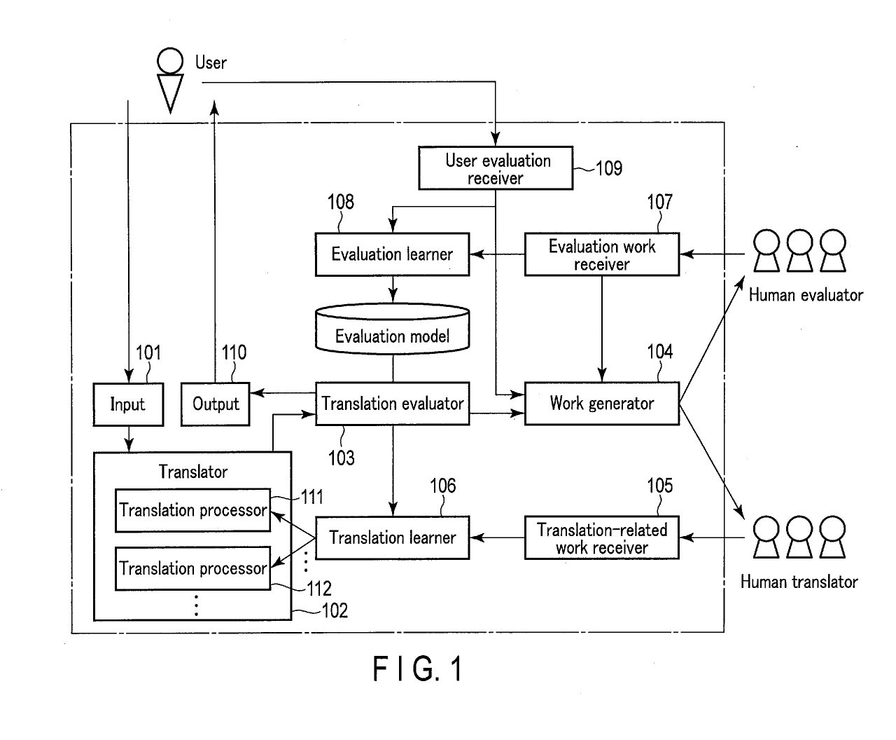

As shown in FIG. 1, a machine translation apparatus according to the first embodiment includes an input 101, a translator 102, a translation evaluator 103, a work generator 104, a translation-related work receiver 105, a translation learner 106, an evaluation work receiver 107, an evaluation learner 108, a user evaluation receiver 109, and an output 110.

The input 101 obtains an original language text from a user, and outputs the original language text to the translator 102.

For example, the input 101 may include a microphone that converts an original language speech received from a user into an electrical signal (an original language speech signal), and a speech recognition module (Automatic Speech Recognition (ASR)) that converts the original language speech signal into an original language text.

The speech recognition module may use any speech recognition scheme. For example, the speech recognition module divides an original language speech signal from the microphone at regular time intervals, and performs a Fourier transform or discrete cosine transform to the divided short-time signal, to generate a feature vector having a cepstrum coefficient as an element. In addition, the speech recognition module may perform, based on the feature vector, Dynamic Programming (DP) matching with a previously constructed speech pattern (template), speech recognition processing using segmentation and phoneme labeling, speech recognition processing using a Hidden Markov Model (HMM), or speech recognition processing providing as a result a category corresponding to a model which maximizes the series likelihood of the feature vector by using a neural network.

Furthermore, the input 101 may include an input device such as a keyboard or a pointing device through which a user inputs an original language text as characters. The input 101 may combine any techniques as long as an original language text is acquired as a result. For example, there may be a case where a user who is remotely present to a machine translation apparatus speaks the original language toward a microphone installed in a communication device such as a smartphone, and a signal conveying an original language speech is transmitted to the machine translation apparatus through a network. In such a case, the input 101 may include a receiving module that receives a transmitted signal and the speech recognition module.

The input 101 may also obtain and output to the translator 102 environment information in addition to an original language text. The environment information is information relating to an input environment of an original language text. Specifically, the environment information may be information relating to a place where an original language text is input (hereinafter, referred to as an input place), an attribution of a user or an interaction partner, or an intention of the user speech. The environment information may be automatically obtained by using various sensors or techniques as described below, or may be directly input by a user.

The environment information relating to the input place of an original language text may be positional information detected by a (near-field) wireless communication system, based on a beacon, or positional information measured by the Global Positioning System (GPS). Otherwise, the environment information relating to the input place of an original language text may be facility information estimated based on positional information and map information.

The environment information relating to the attribution of a user or an interaction partner may be obtained through communication with a communication device that the user or the interaction partner uses, or may be estimated based on the environment information relating to the input place of an original language text. The environment information relating to the intention of user speech may be estimated based on the environment information relating to the input place of an original language text or a present or past original language text.

The translator 102 receives an original language text from the input 101, and performs machine translation processing to the original language text to generate at least one machine translation text. The translator 102 outputs the machine translation text to the translation evaluator 103.

The translator 102 can perform machine translation processing based on any machine translation technique. Translator 102 may, for example, perform transfer-based translation, example-based translation, statistical translation, or interlanguage-based translation.

The translator 102 may include a plurality of translation processors 111, 112, etc. with different translation techniques. Each of the translation processors 111, 112, etc. is implemented by causing a processor which can refer to a database (also referred to as a dictionary) to execute a predetermined program. The translator 102 may allow some of, or all of the translation processors 111, 112, etc. to function relative to each original language text.

The translator 102 may generate and output multiple machine translation texts relative to each original language text as follows:
The translator 102 performs the statistical translation to an original language text to generate and output multiple machine translation texts in the order of likelihood from the highest to the lowest.
The translator 102 performs rule-based translation to an original language text to generate and output a machine translation text of the maximum likelihood and at least one machine translation text obtained when another translation candidate is selected if multiple translation candidates are present for a word in the original language text.
The translator 102 may allow two or more translation processors 111, 112, etc. to function to generate and output multiple machine translation texts relative to one original language text.

In addition, the translator 102 may receive the aforementioned environment information in addition to the original language text from the input 101. In this case, the translator 102 may change a dictionary to be used in accordance with the environment information. For example, if the translator 102 receives the environment information indicating that the input place of the original language text is a medical facility or a commercial facility, the translator 102 uses a dictionary including terms relating to a medical or commercial facility. If the translator 102 receives the environment information indicating that a user is a shop clerk, the translator 102 uses a dictionary including terms or phrases used by a shop clerk. The term “dictionary” used in the embodiment comprehensively indicates a database to be referred to in the machine translation processing, and may be referred to differently depending on the translation technique.

The translation evaluator 103 receives at least one machine translation text from the translator 102. The translation evaluator 103 evaluates the translation quality of each machine translation text by, for example, using an evaluation model.

Specifically, the translation evaluator 103 calculates an evaluation value indicating validity of the provided machine translation text, and determines that the translation quality of the machine translation text is insufficient if the evaluation value is less than a first threshold value. On the other hand, the translation evaluator 103 determines that the translation quality of the provided machine translation text is sufficient if the evaluation value is equal to or greater than a second threshold value. Based on this operation, the translation evaluator 103 may be referred to as a translation quality determiner. The second threshold value is set to be equal to or greater than the first threshold value, and the first and second threshold values may be equal.

The translation evaluator 103 outputs to the work generator 104 the machine translation text that has been determined to be of insufficient translation quality in order to collect a manually created correct translation text (or to receive a manual evaluation with high reliability from a human evaluator). The translation evaluator 103 may output a machine translation text with the highest evaluation value (hereinafter, referred to as a maximum likelihood text) to the output 110, to present the maximum likelihood text to the user. The translation evaluator 103 may output to the translation learner 106 the machine translation text that has been determined to be of sufficient translation quality so that the machine translation text is used for translation learning.

Specifically, the translation evaluator 103 may evaluate the translation quality of machine translation text by using an evaluation model (for example, a support vector machine) in that a learning example including a set of an original language text, a corresponding target language text, and an evaluation value of the corresponding target language text has been learned. The translation evaluator 103 otherwise may evaluate the translation quality of each machine translation text by using an evaluation model that calculates an evaluation value of a machine translation result by regression analysis based on learning examples.

Furthermore, the translation evaluator 103 may estimate a factor of decreasing the translation quality of the machine translation text that has been determined to be of insufficient translation quality. The translation evaluator 103 then reports the estimated decreasing factor to the work generator 104.

The factor of decreasing quality may, for example, be an erroneous word (for example, a translated word is incorrect, or the original language text includes an unknown word (a word unregistered in a dictionary)), an error in word order (for example, the word order of a machine translation text is unnatural in view of language models), and an error in sentence structure (for example, an error in parsing of an original language text).

The work generator 104 receives the machine translation text that has been determined to be of insufficient translation quality from the translation evaluator 103. The work generator 104 may otherwise receive the machine translation text that has been determined to be of insufficient translation quality from the evaluation work receiver 107 or the user evaluation receiver 109 described below. The work generator 104 generates a translation-related work to request a human translator to perform manual translation of an original language text corresponding to the machine translation text of insufficient translation quality.

The work generator 104 requests at least one human translator to perform the translation-related work. Based on this operation, the work generator 104 may be also referred to as a work requester. The work generator 104 may electronically request the translation-related work through emails, file transfer, or web service, or may request the translation-related work by printing the content of the translation-related work on a paper medium by a printer and physically distributing the paper medium to a human translator.

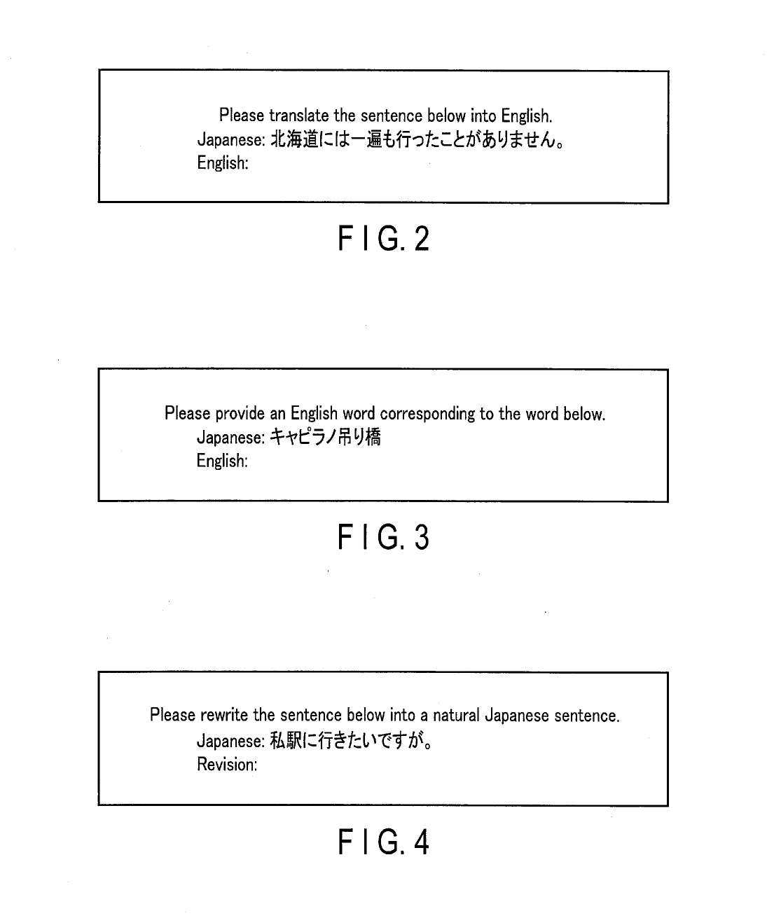

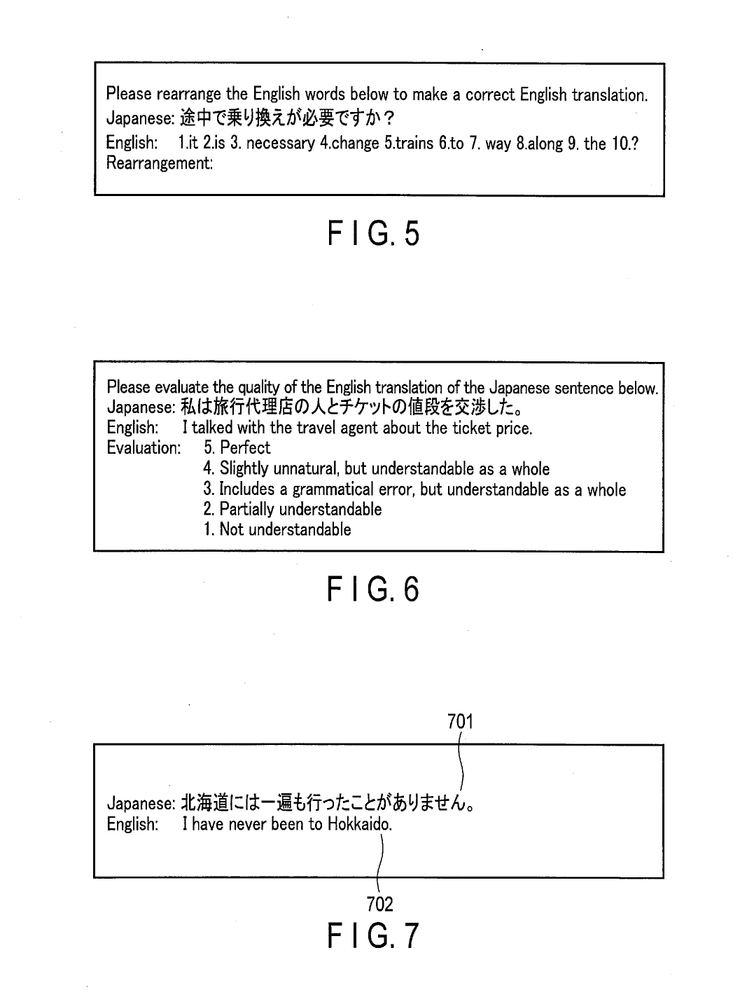

The work generator 104 may generate a translation-related work to request a human translator to perform manual translation of the entire original language text (full text translation), as shown in FIG. 2. The work generator 104 may otherwise generate a translation-related work to request a human translator to perform manual translation of part of the original language text. In comparison with requesting a full text translation, requesting a partial translation may result in reducing time and costs required to obtain a correct sentence translation. The work generator 104 may determine what kind of manual translation is to be requested to a human translator based, for example, on the factor of decreasing the translation quality estimated by the translation evaluator 103, as follows:
If the factor of decreasing the translation quality is that “the original language text includes an unknown word”, the work generator 104 may generate a translation-related work to request a human translator to provide a translation word of the unknown word included in the original language text, as shown in FIG. 3, for example.
If the factor of decreasing the translation quality is “an error in parsing of the original language text”, the work generator 104 may generate a translation-related work to request a human translator to rewrite the original language text, as shown in FIG. 4, for example.
If the factor of decreasing the translation quality is that “the word order of the machine translation text is unnatural in view of language models”, the work generator 104 may generate a translation-related work to request a human translator to rearrange the order of the machine translation text, as shown in FIG. 5, for example.

In addition, the work generator 104 may request a human evaluator to perform manual evaluation to obtain a more appropriate evaluation value when the work generator 104 receives the machine translation text that has been determined to be of insufficient translation quality from the translation evaluator 103 or the user evaluation receiver 109. That is, the work generator 104 generates an evaluation work to request at least one human evaluator to perform manual evaluation of the machine translation text of insufficient quality.

The work generator 104 may electronically request the evaluation work through emails, file transfer, web service, or request the evaluation work by printing the content of the evaluation work on a paper medium by a printer and physically distributing the paper medium to a human evaluator.

The work generator 104 may generate an evaluation work to request a human evaluator to perform five-step evaluation of the machine translation text, as shown in FIG. 6, for example. The work generator 104 may adopt any evaluation criteria as long as the evaluation work evaluation is usable for learning of evaluation models. For example, the work generator 104 may request a human evaluator to perform a two-step evaluation of acceptable or non-acceptable, to perform multifaceted evaluation using multiple evaluation axes (for example, validity or fluency of translation), or to add subjective scores.

The work generator 104 may request to a human translator an entire or partial manual translation of only the machine translation text which has been determined to be insufficient in quality by a human evaluator among the machine translation texts of insufficient quality received from the translation evaluator 103 or the user evaluation receiver 109. That is, the evaluation work which incurs costs lower than the translation-related work can be utilized as a filter. Based on this operation, the machine translation text to be requested to a human translator for manual translation is more suitably filtered. Accordingly, the costs for collecting bilingual data can be reduced without affecting the improvement of translation accuracy.

A human translator or a human evaluator to whom the work generator 104 requests a work may be discretionarily selected. The possible selection methods are indicated below.
Availability of a human translator or a human evaluator to whom the work generator 104 requests a work may be managed. The work generator 104 may prioritize a human translator or a human evaluator who is expected to complete a work sooner, based on the availability, and request the human translator or the human evaluator to perform the translation-related work or the evaluation work.
The work history of a human translator or a human evaluator to whom the work generator 104 requests a work may be managed. The work generator 104 may prioritize a human translator or a human evaluator who has greatly contributed in terms of the amount of work or improvement of translation accuracy, and may request the human translator or the human evaluator to perform the translation-related work or the evaluation work.
The user may assign a preferred human translator, and the work generator 104 may request the translation-related work to the assigned human translator.

The translation-related work receiver 105 receives a translation-related work result that the human translator created in accordance with the translation-related work request, and outputs the result to the translation learner 106. Based on this operation, the translation-related work receiver 105 may be referred to as a translation (work) result receiver. The translation-related work result may include an original language text 701 and a manually translated text which is a manual translation result of the original language text, as shown in FIG. 7, for example.

The translation-related work receiver 105 may receive the translation-related work result in various techniques. For example, the translation-related work receiver 105 may electronically receive a translation-related work result through emails, file transfer or web service, receive a speech-based translation-related work result and convert the result to text through speech recognition processing, or receive a translation-related work result printed on a paper medium and convert the result to text through Optical Character Recognition (OCR).

The translation learner 106 receives the translation-related work result from the translation-related work receiver 105, and executes learning (dictionary updating) of the translator 102 based on the translation-related work result. Specifically, if the translation-related work is a manual translation of the entire original language text, the translation learner 106 performs learning in accordance with the translation technique of a learning target by using the manually translated text included in the translation-related work result as a correct translation, as described below. The translation learner 106 may limit dictionaries to be a learning target if the translator 102 has changed a dictionary to be used in accordance with the environment information.
If the translation technique of a learning target is a translation memory, the translation learner 106 registers to a database (dictionary) an original language text and a corresponding correct translation which are associated with each other.
If the translation technique of a learning target is statistical translation, the translation learner 106 adds bilingual data in which an original language text and a corresponding correct translation are associated with each other to an existing bilingual data, and updates a dictionary by causing a statistical model to learn.
If the translation technique of a learning target is rule-based translation, the translation learner 106 analyzes an original language text and a corresponding correct translation, and generates a conversion rule or a translation word selection rule to update a dictionary. The translation learner 106 may analyze the correspondences between words in the original language text and the correct translation and may update the dictionary so that the priority of a translation word included in the correct translation that corresponds to a certain word included in the original language text is increased.

If the translation-related work is rearrangement of the word order of a machine translation text, the translation learner 106 may perform similar learning by using the rearranged machine translation text included in the translation-related work result as a correct translation. In addition, if the translation learner 106 receives a machine translation text of sufficient translation quality from the translation evaluator 103, the translation learner 106 may perform similar learning by using the machine translation text as a correct translation.

If the translation-related work is provision of a translation word to an unknown word included in an original language text, the translation learner 106 may register to the dictionary the translation word (target language) included in the translation-related work result which is associated with the unknown word (original language). If the translation-related work of an original language text is rewritten, the translation learner 106 may cause the translator 102 to re-translate the original language text included in the translation-related work result.

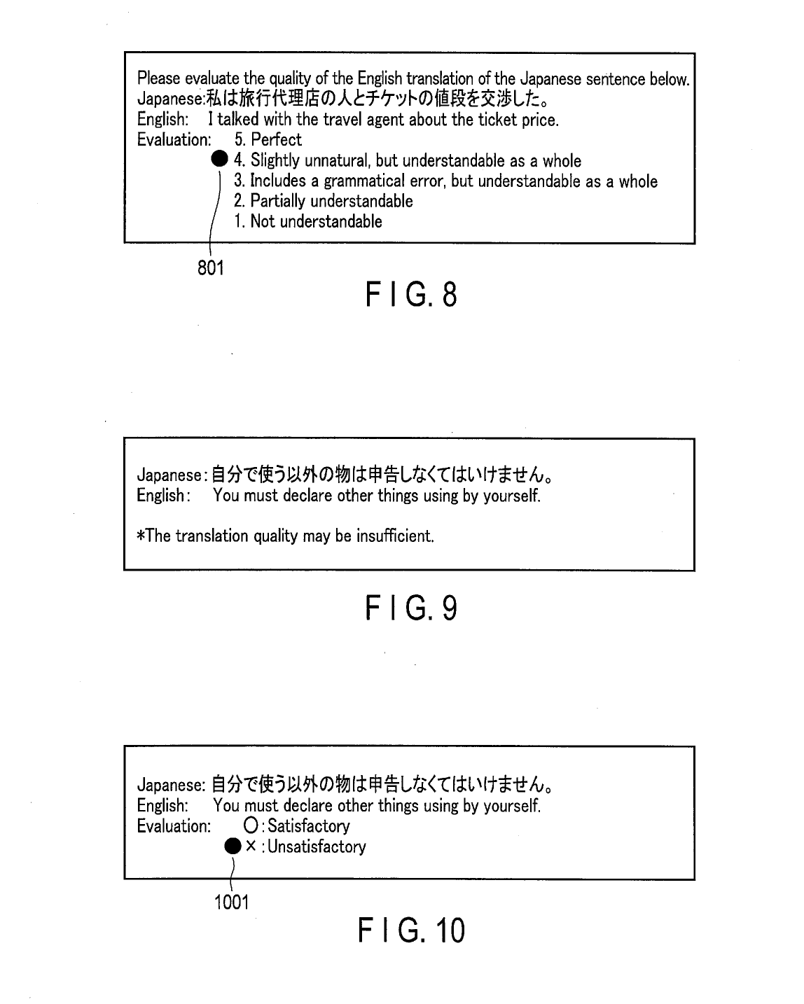

The evaluation work receiver 107 receives the evaluation work result that the human evaluator has created in accordance with the evaluation work request, and outputs the result to the evaluation learner 108. Based on this operation, the evaluation work receiver 107 may be referred to as an evaluation (work) result receiver. The evaluation work result may include a manually evaluated value 801 (point 4 in FIG. 8), as shown in FIG. 8. In addition, the evaluation work receiver 107 may output the evaluation work result to the work generator 104 to extract original language texts that require manual translation.

The evaluation work receiver 107 may receive the evaluation work result in various techniques. For example, the evaluation work receiver 107 may electronically receive an evaluation work result through emails, file transfer, or web service, receive a speech-based evaluation work result and convert the result to text through speech recognition processing, or receive an evaluation work result printed on a paper medium and convert the result to text through OCR.

The evaluation learner 108 receives the evaluation work result from the evaluation work receiver 107, and executes learning of evaluation models referred to by the translation evaluator 103 based on the evaluation work result. The learning method of evaluation models depends on the evaluation technique adopted by the translation evaluator 103. However, the evaluation work result is utilized in any case. The evaluation learner 108 may receive the user evaluation result from the user evaluation receiver 109, and execute learning of evaluation models based on the user evaluation result. For example, the evaluation learner 108 may execute learning of evaluation models so that the evaluation value of the machine translation text that has been evaluated to be sufficient in translation quality by the user or a human evaluator is calculated to be higher.

The output 110 receives and outputs a maximum likelihood text from the translation evaluator 103 so as to present it to the user. The output 110 may present the maximum likelihood text to the user in various techniques, as described below. The output 110 may output a target language translation text other than the maximum likelihood text (for example, manually translated text or machine translation text other than maximum likelihood text).
The output 110 may include a display device such as a display to visually present the maximum likelihood text.
The output 110 may include a speech synthesis module to aurally present the maximum likelihood text. The speech synthesis module may read the machine translation text aloud by performing any speech synthesis processing such as speech synthesis by editing speech segments, format speech synthesis, and speech corpus-based speech synthesis.
The output 110 may print the maximum likelihood text on a paper medium by a printer and physically distribute the paper medium to the user to present the maximum likelihood text.

In addition, if the translation evaluator 103 has determined that the translation quality of the maximum likelihood text is insufficient (i.e., the evaluation value of the maximum likelihood text is less than the first threshold value), the output 110 may present additional information relating to the translation quality in addition to the maximum likelihood text.

The additional information may be text indicating that the translation quality is insufficient, as shown in FIG. 9, text indicating a suggestion for modification of the original language text to the user in order to retry machine translation, text indicating a suggestion for requesting manual translation to the user in order to obtain a more accurate manually translated text, or text indicating a suggestion for waiting for a manually translated text since the translation-related work has been requested.

The user evaluation receiver 109 receives a result of the user's evaluation for the translation quality (user evaluation result) of the maximum likelihood text or another target language translation text presented to the user by the output 110. The user evaluation result may include a two-step manually evaluated value 1001 indicating satisfaction (sufficient translation quality) or dissatisfaction (insufficient translation quality), as shown in FIG. 10, for example. The user evaluation receiver 109 outputs the user evaluation result to the evaluation learner 108 for learning of the evaluation models. In addition, the user evaluation receiver 109 may output to the work generator 104 the (maximum likelihood) machine translation text for which the user evaluation result indicating insufficient translation quality is provided, in order to request manual translation or manual evaluation.

The user evaluation receiver 109 may receive the user evaluation result through various techniques. For example, the user evaluation receiver 109 may electronically receive a user evaluation result through emails, file transfer, or web service, receive a speech-based user evaluation result and convert the result to text through speech recognition processing, or receive a user evaluation result printed on a paper medium and convert the result to text through OCR.

[First Advantageous Effect]

As explained above, the machine translation apparatus according to the first embodiment evaluates a translation quality of machine translation text of an original language text, and requests a human translator to perform manual translation of the original language text if the quality is insufficient. On the other hand, the machine translation apparatus may omit manual translation of the original language text of a machine translation text for which the translation quality is determined to be sufficient. Accordingly, the machine translation apparatus collects an original language text for which a translation of sufficient translation quality cannot be obtained and a corresponding manually translated text (i.e., bilingual data with high learning effectiveness), and executes learning based on the collected bilingual data, thereby effectively improving the accuracy of machine translation.

In addition, the machine translation apparatus automatically evaluates the machine translation text. Accordingly, the need for manually evaluating translations of all the original language texts is eliminated. Thus, the machine translation apparatus can reduce high-cost human processing, and can collect bilingual data of high quality which is effective for improving the accuracy of machine translation. The accuracy of machine translation performed by the machine translation apparatus is improved through learning using the collected bilingual data, and in contrast, the frequency of requesting manual translation due to a machine translation of insufficient translation quality is decreased through the learning.

The machine translation apparatus can estimate a factor of decreasing translation quality for the machine translation text determined to be of insufficient translation quality. The machine translation apparatus may determine what kind of translation-related work is to be executed by a human translator based on the estimated factor of decreasing translation quality. Based on the operation, partial manual translation (for example, providing a translation word) which incurs a lower cost than an entirely manual translation may be adopted, thereby effectively collecting the bilingual data with high quality.

The machine translation apparatus can also present additional information relating to the translation quality if the machine translation text determined to be insufficient in translation quality is presented to the user. Accordingly, the machine translation apparatus can contribute to facilitating communication by providing a clue for determination as to whether or not to use the presented machine translation text, or suggesting a suitable action (for example, re-inputting of the original language text, or requesting or waiting for manual translation) to the user.

The machine translation apparatus can change a dictionary to be used for machine translation in accordance with the environment information relating to the input environment of the original language text. Based on this operation, machine translation suitable for the actual utilization environment can be realized. In addition, the machine translation apparatus can limit dictionaries to be a learning target in accordance with the environment information. Based on this operation, a dictionary suitable for a particular environment can be effectively constructed by using the bilingual data including an original language text input under the particular environment.

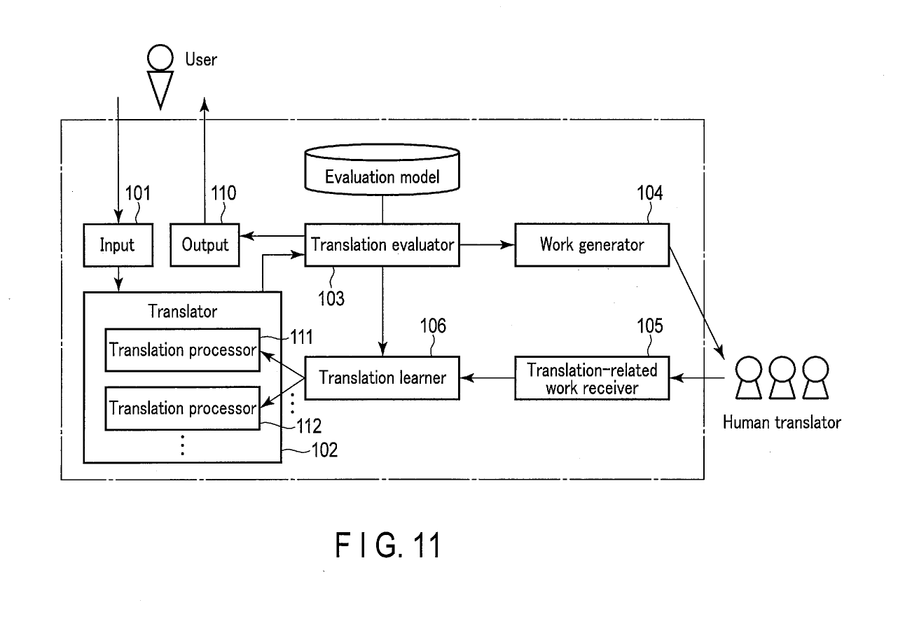

The first advantageous effect may be obtained by a first variation example of the machine translation apparatus in which the evaluation work receiver 107, the evaluation learner 108 and the user evaluation receiver 109 shown in FIG. 1 are eliminated, as shown in FIG. 11.

[Second Advantageous Effect]

The machine translation apparatus according to the first embodiment can collect a manual evaluation result for the translation quality of a machine translation text by at least one human evaluator, and can learn an evaluation model that is to be referred to for automatic evaluation of the translation quality. For example, the machine translation apparatus may execute learning of an evaluation model so that the evaluation value of a machine translation text that has been evaluated as sufficient in translation quality by a human evaluator is calculated to be higher. Accordingly, the accuracy of an automatic evaluation of the translation quality performed by the machine translation apparatus is improved through learning using the manual evaluation result, and in contrast, the frequency of requesting an unnecessary manual translation due to mis-evaluation of the translation quality is decreased through the learning.

The machine translation apparatus may request to a human translator an entire or a partial manual translation of a machine translation text which has been determined to be insufficient in translation quality by a human evaluator among the machine translation texts determined to be of insufficient translation quality. Based on this operation, a machine translation text to be requested to a human translator for manual translation is more appropriately filtered. Accordingly, the costs for collecting bilingual data can be reduced without affecting the improvement of translation accuracy.

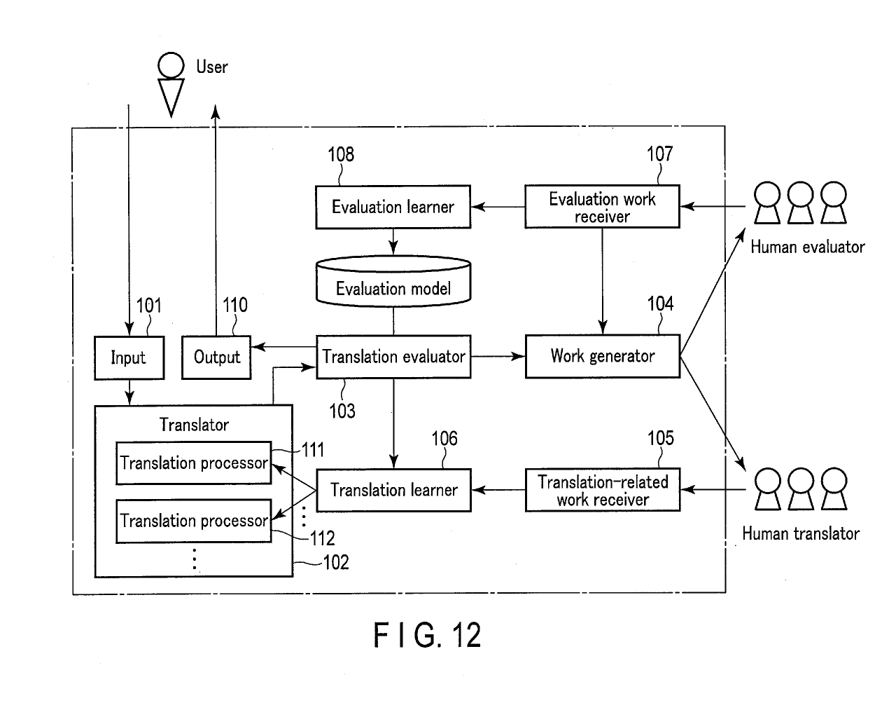

The second advantageous effect may be obtained by a second variation example of the machine translation apparatus in which the user evaluation receiver 109 shown in FIG. 1 is eliminated, as shown in FIG. 12.

[Third Advantageous Effect]

The machine translation apparatus according to the first embodiment can receive an evaluation result for the translation quality from a user to whom the (maximum likelihood) machine translation text is presented. The machine translation apparatus may request a manual translation or a manual evaluation to a particular machine translation text if the particular machine translation which has been determined to be sufficient in translation quality and presented to the user is determined to be insufficient in translation quality by the user. Thus, according to the machine translation apparatus, the accuracy of automatic evaluation of translation accuracy can be effectively improved even in the case where the accuracy of the automatic evaluation of translation quality is not sufficiently high.

The third advantageous effect may be obtained by a third variation example in which the user evaluation receiver 109 is added to the first variation example.

At least a part of the process described in the embodiment can be realized using a computer (or an embedded system) as hardware. Herein, a computer is not limited to a personal computer; it may be any apparatus on which a program (software) can be executed, such as a processing unit included in an information processing apparatus, or a micro controller, for example. More than one computer may be used. For example, a system in which a plurality of apparatuses are connected by the Internet or LAN may be adopted. It is also possible to execute at least a part of the process described in the foregoing embodiment with a middleware (e.g., OS, database management software, network, etc.) of a computer in accordance with instructions in a program installed on the computer.

The program to execute the above process may be stored on a computer-readable storage medium. A program is stored on a storage medium as a file in an installable or an executable format. A program may be stored on one storage medium, or may be divided into multiple storage media. A storage medium should be capable of storing a program and be computer-readable. A storage medium may be a magnetic disk, a flexible disk, a hard disk, an optical disk (such as CD-ROM, CD-R, DVD-ROM, DVD±RW, Blue-ray (registered trademark) Disc, etc.), a magneto-optical disk (MO, etc.) or a semiconductor memory. In addition, a storage medium is not necessarily independent from a computer, and may be installed in a computer. A program may be transmitted through a LAN or the Internet, and transitorily or non-transitorily stored in a storage medium.

A program to execute the above processing may be stored on a computer (server) connected to a network, and downloaded by a computer (client) through the network.

The various functional sections explained in the above embodiment may be implemented by using a circuit. A circuit may be a dedicated circuit for implementing a particular function, or a generic circuit such as a processor.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A machine translation apparatus comprising:
a translator that performs machine translation of an original language text based on a dictionary to generate at least one machine translation text;
a determiner that calculates an evaluation value indicating validity of the machine translation text using an evaluation model, and determines that a translation quality of the machine translation text is insufficient when the evaluation value is less than a first threshold value;
a requester that requests a human translator to perform a manual translation-related work relative to the original language text corresponding to the machine translation text that has been determined to be insufficient in translation quality;
a translation result receiver that receives a translation-related work result that the human translator has created in response to a request of the manual translation-related work; and
a translation learner that updates the dictionary based on the translation-related work result.

2. The apparatus according to claim 1, wherein the determiner determines, when the evaluation value of the machine translation text is equal to or greater than a second threshold value which is equal to or greater than the first threshold value, that a translation quality of the machine translation text is sufficient, and
the translation learner updates the dictionary based on the machine translation text that has been determined to be sufficient in translation quality.

3. The apparatus according to claim 1, wherein the determiner estimates a factor of decreasing the translation quality of the machine translation text that has been determined to be of insufficient translation quality, and
the requester determines a type of the translation-related work to be requested to the human translator based on the factor of decreasing the translation quality.

4. The apparatus according to claim 3, wherein the determiner estimates that the factor of decreasing the translation quality is an erroneous word, an error of word order, or an error of sentence structure.

5. The apparatus according to claim 1, wherein the requester requests a human evaluator to perform a manual evaluation work for the translation quality of the machine translation text that has been determined to be insufficient in translation quality, and the apparatus further comprising:
an evaluation result receiver that receives an evaluation work result that the human evaluator has created in response to a request of the manual evaluation work; and
an evaluation learner that executes learning of the evaluation model based on the evaluation work result.

6. The apparatus according to claim 5, wherein the requester limits an original language text to be requested a human translator to perform a manual translation to the original language text corresponding to the machine translation text that has been determined to be insufficient in translation quality.

7. The apparatus according to claim 1, further comprising:
an output that outputs a maximum likelihood text that has a highest evaluation value among the at least one machine translation text; and
a user evaluation receiver that receives an evaluation for a translation quality of the maximum likelihood text from a user of the machine translation,
wherein the requester requests a human translator to perform a manual translation of the original language text corresponding to the maximum likelihood text when the user evaluation receiver has received the evaluation indicating that the maximum likelihood text is insufficient in translation quality.

8. The apparatus according to claim 7, wherein the output outputs additional information relating to the translation quality of the maximum likelihood text in addition to the maximum likelihood text when an evaluation value of the maximum likelihood text is less than the first threshold value.

9. The apparatus according to claim 1, further comprising an input that obtains the original language text and environment information relating to an input environment of the original language text,
wherein the translator changes a dictionary to be referred to in accordance with the environment information, and
the translation learner limits a dictionary to be learned based on the environment information.

10. The apparatus according to claim 1, wherein the translator includes translation processors that are different in at least one of a translation technique and a dictionary to be used.

11. A machine translation method comprising:
performing machine translation of an original language text based on a dictionary to generate at least one machine translation text;
calculating an evaluation value indicating validity of the machine translation text using an evaluation model, and determining that a translation quality of the machine translation text is insufficient when the evaluation value is less than a first threshold value;
requesting a human translator to perform a manual translation-related work relative to the original language text corresponding to the machine translation text that has been determined to be insufficient in translation quality;
receiving a translation-related work result that the human translator has created in response to a request of the manual translation-related work; and
updating the dictionary based on the translation-related work result.

12. A non-transitory computer readable storage medium storing instructions of a computer program which when executed by a computer results in performance of steps comprising:
performing machine translation of an original language text based on a dictionary to generate at least one machine translation text;
calculating an evaluation value indicating validity of the machine translation text using an evaluation model, and determining that a translation quality of the machine translation text is insufficient when the evaluation value is less than a first threshold value;
requesting a human translator to perform a manual translation-related work relative to the original language text corresponding to the machine translation text that has been determined to be insufficient in translation quality;
receiving a translation-related work result that the human translator has created in response to a request of the manual translation-related work; and
updating the dictionary based on the translation-related work result.
